(19) United States
(12) Patent Application Publication
(10) Pub. No.: US 2012/0236087 A1
(43) Pub. Date: Sep. 20, 2012

(54) INK CARTRIDGE FOR INKJET PRINTERS

(75) Inventors: Lucio Bianco, Jona (CH); Daniel Sulser, Wald (CH)

(73) Assignee: PELIKAN HARDCOPY PRODUCTION AG, Wetzikon (CH)

(21) Appl. No.: 13/498,465

(22) PCT Filed: Feb. 18, 2010
(86) PCT No.: PCT/EP2010/052059

§ 371 Date: May 30, 2012

(30) Foreign Application Priority Data
Sep. 28, 2009 (EP) PCT/EP2009/062530
Jan. 18, 2010 (EP) PCT/EP2010/050510

(51) Int. Cl. B41J 2/175

(52) U.S. Cl. 347/86

(57) ABSTRACT

An ink cartridge for an inkjet printer having a light-transmitting part and a light-receiving part. The ink cartridge includes a side face, an ink-receiving space including an extension that projects beyond the side face, and fill level detection means arranged on the side face. The fill level detection means includes a first light-beam-deflecting surface that includes a light beam entry surface which is arranged outside the ink cartridge and faces the light-transmitting part, a deflecting surface configured to be wetted with ink or dewetted of ink inside the cartridge in dependence upon a fill level of ink in the ink-receiving space, and a second light-beam-deflecting surface that includes a light beam exit surface which is arranged outside the ink cartridge and faces the light-receiving part. The first and second light-beam-deflecting surfaces are combined with the deflecting surface to form a common component that is part of the extension.

### CROSS REFERENCE TO RELATED APPLICATIONS

This application is a Section 371 national phase patent application of International Patent Application No. PCT/EP2010/052059, filed Feb. 18, 2010, which claims priority to International Patent Application No. PCT/EP2009/062530, filed Sep. 28, 2009, and to International Patent Application No. PCT/EP2010/050510, filed Jan. 18, 2010, the entire contents all of which are hereby incorporated by reference herein.

### BACKGROUND

The present invention relates to an ink cartridge for inkjet printers or like recording devices.

Particularly in the case of ink cartridges that are connected to a print head by means of hoses, but also in the case of other cartridges, it must be ensured that the hoses always remain full of ink. Otherwise there is a risk of local drying-out and interruption of the ink supply. For that reason it is also important that the fill level of an ink cartridge be monitored. For that purpose, printers have devices which ascertain the fill level of the ink cartridge and, in particular, ascertain whether the ink cartridge is empty or will shortly become empty, so that continued printing can be prevented. An indicator shows that it is necessary to replace the cartridge. The devices of the said kind comprise, on the printer side, a light-transmitting part and a light-receiving part, between which there are positionable fill level detection means associated with the printer cartridge. In the prior art in accordance with DE 10 2007 001 084 A1, the ink cartridge has for that purpose a fill level indicator comprising a light-impermeable or alternatively light-reflecting tab, the tab being connected to a float arranged inside the ink cartridge or the housing thereof in such a way that, as the fill level drops, the tab is movable either into or out of the region of a photoelectric barrier arranged in the printer. Alternatively, the tab can be arranged on a pivotally mounted float device. When the fill level falls below a predetermined level, the photoelectric barrier is cleared, that is to say the light beam passes unhindered from the light-transmitting part through the cartridge to the light-receiving part. As a result, a predetermined procedure is initiated, with the need to replace the cartridge being indicated.

In a further piece of prior art, the fill level detection means comprise a first light-beam-deflecting surface, which is arranged outside the cartridge and faces the light-transmitting part, a deflecting prism which can be wetted with ink or dewetted of ink inside the cartridge in dependence upon the fill level, and a second light-beam-deflecting surface which is arranged outside the cartridge and faces the light-receiving part. When the deflecting prism arranged inside the cartridge is wetted as a function of the fill level, the light beam, which has been directed into the deflecting prism by the first light-beam-deflecting surface, enters the ink and is absorbed therein. When the fill level drops below the deflecting prism, the prism is dewetted and the light beam entering the deflecting prism undergoes total reflection, so that it passes out of the deflecting prism again. The emergent light beam is then directed into the light-receiving part by the second light-beam-deflecting surface. Then, in turn, the afore-mentioned signal is given that the cartridge is empty and needs to be replaced.

This last-mentioned solution has the disadvantage that the first and second light-beam-deflecting surfaces each need to be provided with a separate light-reflecting surface. For that purpose, in the prior art the surfaces in question are provided with high-gloss aluminium foils. The expenditure for manufacturing the first and second light-beam-deflecting surfaces is accordingly high. In addition, such deflecting surfaces can very easily be damaged by improper handling and thus rendered unusable.

### SUMMARY

The present invention is therefore based on the problem of improving the last-mentioned version of an ink cartridge in such a way that the fill level detection means, especially light-beam-deflecting means, can be produced more simply, with the result that the ink cartridge as a whole is simpler and more economical to produce.

One of the aspects of the present invention lies in the fact that the first and second light-beam-deflecting surfaces are part of a deflection element that can be wetted with ink or dewetted of ink, which deflection element is in turn part of the upper side of an extension of the ink-receiving space, which extension projects forwards beyond the front face of the cartridge. With this construction principle, the first and second light-beam-deflecting surfaces, as well as a light-beam-deflecting surface that comes into contact with the ink, are integral parts of the cartridge. The production of such a cartridge in an injection molding process is quite simple. In particular, it should be pointed out that by virtue of the extremely compact form and the resulting short beam path, it is also possible to use very small, low-intensity light sources having low excitation energy, while nevertheless reliably detecting the fill level inside the ink cartridge.

In an especially simple and accordingly advantageous embodiment, the first and second deflecting surfaces, which are each arranged outside the ink cartridge, as well as the deflecting surface that can be wetted with ink or dewetted of ink, are part of an approximately U-shaped deflection element. The light beam deflection element so constructed defines a kind of multiple prism. The total fill level detection device is a one-piece, integrated reflection device.

The first and second deflection surfaces are preferably formed on the two limbs and the deflecting surface that can be wetted with ink or dewetted of ink is formed on the bridge arranged between the two limbs of the approximately U-shaped deflection element.

The approximately U-shaped deflection element is so configured that the light beam emitted by the transmitting part enters the deflection element and, if the deflecting surface is wetted with ink, is absorbed by the ink but, when the deflecting surface is dewetted of ink, leaves the light beam deflection element again on the side facing the light-beam-receiving part. The light beam deflection element is therefore constructed so that the light beam is deflected or reflected a number of times between the light beam entry surface and the light beam exit surface inside the light beam deflection element, the exiting of the light beam depending upon whether or not the deflecting surface facing the ink chamber is wetted with ink.

As already indicated above, the approximately U-shaped deflection element is preferably formed on the upper side—in the mounted state of the cartridge—of the extension of the ink-receiving space of the cartridge, which extension projects beyond a side face, especially the front face, of the cartridge.

Furthermore, depending upon the materials used for the deflection element it has proved advantageous for the two limbs of the approximately U-shaped deflection element to enclose an angle of less than 90°, especially approximately from 35° to 50°.

As already mentioned, the light beam is to be reflected between the light beam entry surface and the light beam exit surface only inside the light beam deflection element, unless the light-beam-deflecting surface that faces the ink has been wetted with ink, in which case the light beam is diverted into the ink and absorbed by the ink. In that case, the light beam does not reach the light-receiving part. For the afore-mentioned purpose, the two limbs of the approximately U-shaped deflection element define between the first external deflecting surface and the second external deflecting surface, that is to say between the light beam entry surface and the light beam exit surface, in each case at least one, especially at least two, further internal light-beam-deflecting surface(s).

In an especially preferred embodiment, the free ends of the two limbs of the approximately U-shaped deflection element each comprise a deflecting prism having an outwardly directed peak, the oblique surfaces facing the light-transmitting part and the light-receiving part defining the first external and second external light-beam-deflecting surfaces, that is to say the light beam entry surface and the light beam exit surface, respectively, while the respective other oblique surfaces form an internal light-beam-deflecting surface.

The internally located light-beam-deflecting surfaces can additionally be mirrored, so that in the dewetted state a greater proportion of at least the incoming light beam is reflected.

The two afore-mentioned oblique surfaces of the deflecting prisms arranged at the ends preferably enclose an angle of approximately from 45° to 100°, especially approximately from 60° to 70°.

In connection with the afore-mentioned deflecting prisms it should also be mentioned that, in the case of one specific embodiment, the light-beam-deflecting surfaces facing the light-transmitting part and the light-receiving part are in cross-section each of shorter dimensions than the respective opposite light-beam-deflecting surfaces.

It would also be possible for the two limbs of the approximately U-shaped deflection element to be brought together so that the mutually facing surfaces define, in cross-section, a “V” having its peak directed downwards when the cartridge is in the mounted state. This is a modified embodiment of the light beam deflection element.

Preferably, an ink outlet is formed on the front face of the cartridge close to the lower face thereof, the fill level detection means being arranged above the ink outlet.

The mentioned fill level detection means can, in principle, be a separate component of the cartridge or the cartridge housing, but they are preferably an integral part thereof. In the latter case, the light beam deflection element is produced together with the ink cartridge, at least together with the front face of the ink cartridge, including the extension, in an injection-moulding process.

In the mounted state of the ink cartridge, a light beam emitted by the light-transmitting part is deflected, undergoing total reflection, by means of the first limb of the approximately U-shaped light beam deflection element, which first limb faces the light-transmitting part, onto the upper side of the extension of the ink-receiving space of the ink cartridge arranged therebelow, which extension projects beyond a side face, especially a front face, of the cartridge, which upper side is in contact with the ink when the ink cartridge is sufficiently full. In that case the light beam is then absorbed in the ink. As soon as that upper side or the light-beam-deflecting surface has been dewetted, total reflection again occurs at that location, the light beam being reflected into the second limb of the approximately U-shaped light beam deflection element, which second limb faces the light-receiving part. By means of that second limb, the light beam is then diverted towards the light-receiving part. This triggers a signal which indicates that the ink cartridge is substantially empty and needs to be replaced. If, therefore, the deflecting surface arranged inside the ink cartridge has been wetted with ink, the light beam is not deflected at that location but is simply diverted into the ink and absorbed therein. When the fill level falls to such an extent that the deflecting surface is dewetted, the light beam is further directed, by means of the total reflection that takes place at that location, towards the light beam exit surface of the second limb of the approximately U-shaped light beam deflection element, which second limb faces the light-receiving part.

By virtue of the construction according to the invention there is no need for the known float device or for the separate reflecting surfaces that have to be provided by suitable measures, either by the application of light-reflecting foils or by the vapour-deposition of a light-reflecting layer. If a particularly weak light source is employed and/or a material is used that, for example, tends towards relatively strong Tyndall scattering of the light, it is nevertheless possible for the light-reflecting faces of the two limbs of the approximately U-shaped light beam deflection element, with the exception of the light beam entry surface and the light beam exit surface, to be mirrored. As a result, a greater proportion of the incoming light is reflected. Losses caused by scattering in the plastics or by a non-ideal angle of incidence can readily be compensated for in this way.

As mentioned above, an important aspect of the present invention lies in the fact that external light-beam-deflecting surfaces, that is to say those arranged outside the cartridge, are an integral part of an extension of the ink-receiving space of the ink cartridge, which extension projects beyond a side face, especially the front face, of the cartridge, that extension comprising an internal light-beam-deflecting surface that can be wetted with ink or dewetted of ink in dependence upon the fill level. The latter surface is part of a bridge portion formed between the two afore-mentioned limbs of the approximately U-shaped light beam deflection element.

It should also be mentioned at this point that it is possible to provide in combination, but also independently of the afore-mentioned embodiments of a fill level detection device, a so-called mounting detection device which is operative between the light-transmitting part and the light-receiving part or a separate light beam detector, in such a way that the mounting and/or demounting of the ink cartridge is detectable. For that purpose, the surface of the mounting detection device that faces the light beam extends at an angle of greater than 90° to the incoming light beam and is also textured. It especially has a corrugated texture. It is thereby ensured that, for example, when the ink cartridge is mounted or demounted, ink droplets splashing from the ink outlet are retained on the mounting detection device or on the textured surface thereof and do not drip onto the external light-beam-deflecting surfaces located therebelow.

The afore-mentioned surface of the mounting detection device that faces the light beam is preferably part of a light beam interruption element that is mounted so as to be movable relative to the ink cartridge, which interruption element allows any desired sequence of signals, especially an asymmetric sequence, when the ink cartridge is mounted and demounted. Such a light beam interruption element is preferably of finger-like form with a circular or elliptical cross-section.

The cartridge can also have an upper interrupter projection, especially arranged at the upper front edge, the irradiated surfaces of which slope both in the vertical direction and in the horizontal direction, and also horizontal fluting or a corrugated texture such that the peaks and troughs of the corrugations run approximately horizontally. That form of surface also serves to retain any ink droplets accidentally reaching those surfaces. Such droplets should therefore in no case drip onto the light-beam-deflecting surfaces of the fill level detection device.

A preferred embodiment of an ink cartridge constructed in accordance with the invention is explained below with reference to the accompanying drawings.

### BRIEF DESCRIPTION OF THE DRAWINGS

FIG. 1 shows an embodiment of an ink cartridge constructed in accordance with the invention in a perspective view seen obliquely from the front and from above;

FIG. 2 shows the ink cartridge according to FIG. 1 seen obliquely from the front; and

FIG. 3 is a diagrammatic sectional view of the fill level detection means of the ink cartridge according to FIGS. 1 and 2 on an enlarged scale.

### DETAILED DESCRIPTION

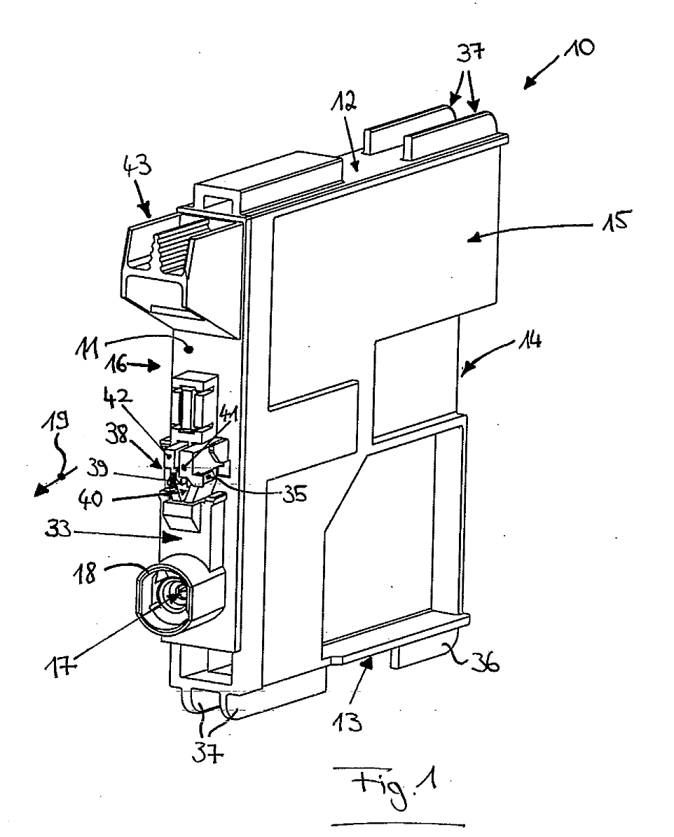

The ink cartridge shown in FIG. 1 is indicated by reference numeral 10. It has a shallow parallelepipedal shape having, in the direction of mounting, a front face 11, top face 12, lower face 13, rear face 14 and side faces 15 and 16. An ink outlet 17 is formed on the front face 11 close to the lower face 13. The ink outlet projects beyond the front face 11. Since these are structural features known per se, more detailed description is unnecessary at this point. The ink outlet is assigned a corresponding printer-side connection. The mounting direction is indicated by arrow 19 in FIG. 1.

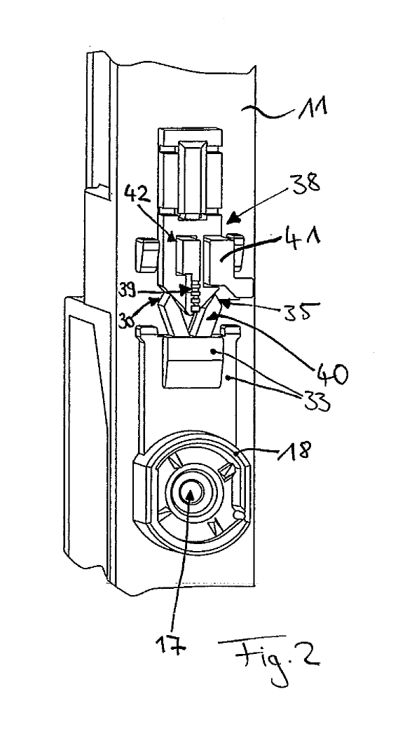

Furthermore, on the front face 11 there are arranged fill level detection means. The latter comprise a first light-beam-deflecting surface 30, which is arranged outside the cartridge 10 and faces a light-transmitting part (not shown herein) and which defines a so-called light beam entry surface. Arranged opposite there is a light beam exit surface 35 through which the light beam, on undergoing total reflection inside a light beam deflection element 40 assigned to those two faces, emerges again and strikes a light-receiving part (see also FIG. 2).

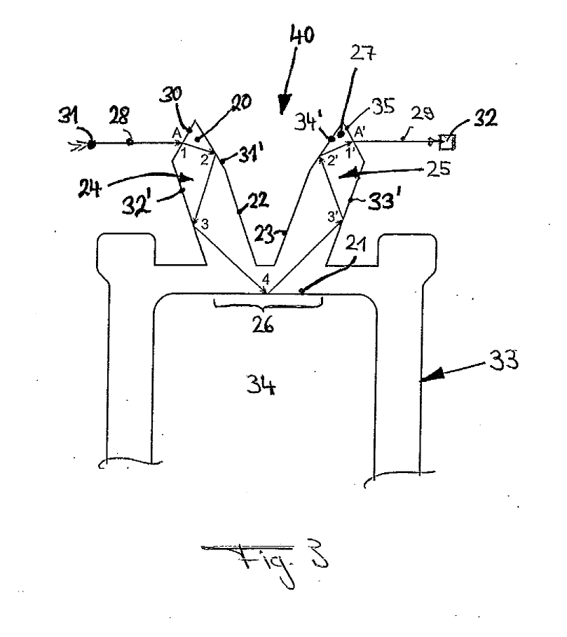

FIG. 3 shows the afore-mentioned light beam deflection element 40 in slightly more detail; FIG. 3 also shows, in particular, the said total reflection of the incoming light beam in diagrammatic form. In FIG. 3 the light-transmitting part is indicated by reference numeral 31 and the light-receiving part by reference numeral 32.

The afore-mentioned light-beam-deflecting surfaces 30, 35 are combined with a deflecting surface 21 (see FIG. 3) that can be wetted with ink 34 or dewetted of ink 34 inside the cartridge 10 in dependence upon the fill level, to form a common component which is part of an extension 33 of the ink-receiving space of the ink cartridge 10, which extension projects beyond a side face, here namely beyond the front face 11, of the cartridge 10. In particular, the first deflecting surface arranged outside the ink cartridge 10 and the second deflecting surface arranged outside the ink cartridge, that is to say the light beam entry surface 30 and the light beam exit surface 35, as well as the deflecting surface 21 that can be wetted with ink or dewetted of ink, are part of an approximately U-shaped deflection element 40. In accordance with FIG. 3, the light beam entry surface 30 and the light beam exit surface 35 are formed on the two limbs 24, 25 and the deflecting surface 21 that can be wetted with ink 34 or dewetted of ink 34 is formed on the bridge 26 arranged between the two limbs 24, 25 of the approximately U-shaped deflection element 40.

Furthermore, as can clearly be seen in all the Figures, in the mounted state of the cartridge 10 the approximately U-shaped deflection element 40, especially the part thereof comprising the afore-mentioned bridge 26, forms the upper side or upper boundary of the extension 33 of the ink-receiving space of the cartridge 10, which extension projects beyond the front face 11 of the cartridge 10.

The two limbs 24, 25 of the deflection element 40 enclose an angle of less than 90°, especially approximately from 35° to 50°, preferably approximately 45°. Ultimately that angle depends upon the material of the deflection element and also upon the thickness and the length of the limbs 24, 25. As can be seen very clearly in particular in FIG. 3, the two limbs 24, 25 of the deflection element 40 define between the first external deflecting surface, or light beam entry surface 30, and the second external deflecting surface, or light beam exit surface 35, in each case at least one, here two, further internal light-beam-deflecting surface(s) 31′, 32′ and 33′, 34′, respectively.

In the embodiment shown, the free ends of the two limbs 24, 25 each comprise a deflecting prism 20, 27 having an outwardly directed peak. The oblique surfaces facing the light-transmitting part 31 and the light-receiving part 32 define the first external deflecting surface, or light beam entry surface 30, and the second external deflecting surface, or light beam exit surface 35, respectively, while the respective other, that is to say opposite, oblique faces form an internal light-beam-deflecting surface, indicated by reference numerals 31′, 34′ in FIG. 3. The oblique surfaces 30, 31′ and 34′, 35 of the deflecting prisms 20, 27 arranged at the ends enclose an angle of approximately from 35° to 60°, especially approximately 45°. That angle likewise depends inter alia upon the material of the deflection element 40 and therefore upon the refractive index thereof.

In the embodiment shown, the light-beam-deflecting surfaces 30, 35 facing the light-transmitting part 30 and the light-receiving part 31 are, in the cross-section of the respectively associated deflecting prisms 20, 27, of shorter dimensions than the respective opposite light-beam-deflecting surfaces 31′, 34′. Those dimensions likewise depend upon the material of the light beam deflection element 40 and therefore upon the corresponding refractive index. It is necessary to ensure only that the light beam reliably strikes the respective internal light-beam-deflecting surfaces 31′, 34′.

As already mentioned, the two limbs 24, 25 of the light beam deflection element 40 are an integral part of the extension 33 of the ink-receiving space, which extension projects forwards beyond the front face 11 of the cartridge.

The dimensions of the two limbs 24, 25 and of the bridge portion 26, arranged therebetween, of the light beam deflection element 40 are such that the beam path, on undergoing total reflection, that is to say when the deflecting surface 21 is dewetted, remains inside the two afore-mentioned limbs and the afore-mentioned bridge portion. Entry and exit take place solely at the light beam entry surface 30 and light beam exit surface 35, respectively. Accordingly, the beam path cannot be disrupted by external influences. Only the incoming light beam 28 and the outgoing light beam 29 are located outside the fill level detection means, which is, however, necessitated by the system.

The inclination of the light-beam-deflecting surfaces and their spacing from one another depend inter alia upon the ink on the one hand and upon the material from which the light beam deflection element 40 is made on the other hand. For example, when the material used is polypropylene the following conditions must be taken as a basis:

Refractive Indices
Air: nₐᵢᵣ≈1.00
Polypropylene: nₚₚ≈1.5
Ink: nᵢₙₖ≈1.40

This results in the following critical angles between the afore-mentioned light-deflecting surfaces:
PP/air: Θ_{c}=asin (nₐᵢᵣ/nₚₚ)≈42°
PP/ink: Θ_{c}=asin (nᵢₙₖ/nₚₚ)≈69°

In that arrangement it is preferable to choose the following refraction angles at the positions shown in FIG. 3:
A=30° (entry angle)
1=19.5°
2=45°
3=59°
4=51°
3′=59°
2′=45°
1′=19.5°
A′=30° (exit angle)

Those angles ensure reliable operation even with production-related manufacturing tolerances, with deviations of up to ±1.5 to 2.0° of course also being operationally reliable.

In principle, it is also conceivable for the incoming light beam to be deflected by the first external entry surface directly onto the surface that can be wetted with ink and, in the event of total reflection, to be deflected directly onto the second external light exit surface.

It should also be mentioned that the ink cartridge 10 has an air-admission opening or air-admission channel which is assigned a fluid-tight but air-permeable barrier element, especially in the form of a foil-like membrane. That membrane can be mounted internally or externally over the air-admission opening.

If the air inlet is located above the ink outlet 17, that air inlet is connected to an air-admission channel extending inside the front face 11, which air-admission channel opens into the ink-receiving space in the upper region of the ink cartridge 10. The afore-mentioned fluid-tight but air-permeable membrane is arranged in the region of that opening. The cross-section of the air outlet opening that opens into the ink-receiving space is preferably larger than the cross-section of the air-admission channel, so as to provide the membrane extending over the air outlet opening with a correspondingly larger “permeation surface area”. The water breakthrough pressure of the membrane is in the range of approximately from 100 to 180 kPa, especially in the range of approximately from 140 to 160 kPa, in accordance with JIS L 1092. The membrane is hydrophobically and/or oliophobically treated depending upon the ink used. The air permeability of the membrane is in the range of from 3 to 9 s/100 cm³ in accordance with JIS P 8117. The afore-mentioned air-admission elements are an integral part of the front face 11, which in turn is preferably produced separately from the remainder of the housing of the ink cartridge 10.

The air-admission channel can also be assigned a non-return valve that is openable only in the direction into the ink-receiving space. This is an alternative solution to the afore-mentioned fluid-tight but air-permeable barrier element, preferably in the form of a foil-like membrane.

Preferably the ink outlet 17 and the inlet opening of the air-admission channel associated therewith are sealable by a common sealing foil which is arranged to be removed or ruptured when the ink cartridge is inserted. The sealing foil extends over the opening of an annular projection 18 inside which there are arranged the ink outlet 17 and the inlet opening of the air-admission channel (not shown herein) associated therewith.

As already mentioned, in an embodiment that is especially advantageous from the production standpoint the face 11 of the housing bounding the ink-receiving space, which face includes the ink outlet 17, has a separately manufactured housing wall, here the front wall, which in addition to the ink outlet 17 also comprises at least the air-admission channel together with the air inlet and air outlet and also the semi-permeable membrane or non-return valve, for example in the form of a valve flap.

Both the top wall and the base wall each have guide rails 36, 37 extending in the direction of mounting. These are measures known per se which do not require further explanation. The guide rails correspond to complementary guide grooves in housings or cartridge holders assigned to the ink cartridge in an inkjet printer or like printing apparatus.

In respect of the afore-mentioned measures for admitting air into the ink cartridge during operation for the purpose of sufficient pressure equalisation inside the ink-receiving space, reference is made in addition to the content of German Patent Application No. 10 2009 026 081.1, which likewise originates from the Applicant.

The ink cartridge according to FIGS. 1 and 2 also comprises a mounting detection device which is operative between the light-transmitting part 31 and the light-receiving part 32 in such a way that the mounting and/or demounting of the ink cartridge 10 is detectable. Specifically, the mounting detection device 38 has a light beam interruption element 39 mounted so as to be movable relative to the ink cartridge 10, that is to say relative to the fill level detection device 40, which interruption element allows any desired sequence of signals, especially an asymmetric sequence, when the ink cartridge is mounted or demounted. The light beam interruption element 39 is moved with or carried along by a driver element, especially in the form of a tappet 41, which is operative on mounting/demounting of the ink cartridge and is likewise mounted so as to be movable relative to the ink cartridge, but the movement or carrying-along of the light beam interruption element is in each case effected after a time delay relative to the movement of the tappet 41. The driving of the light beam interruption element 39 is effected in such a way that, on mounting and demounting of the ink cartridge, the associated light-beam-receiving part 32 generates a different number of signals (interruption signals), especially only one signal on mounting but not on demounting of the ink cartridge.

On mounting of the ink cartridge 10, the driver element or tappet 41 is movable into the ink cartridge or into a container defining the ink cartridge against the action of a resilient element. The mounting direction is indicated by arrow 19 in FIG. 1. As can be seen in FIG. 1 and also in FIG. 2, the tappet 41 projects beyond the front face 11 located in the mounting direction. On mounting of the cartridge 10, the tappet is arranged to be pressed into the cartridge container against the action of the mentioned compression spring and, on so doing, the tappet 41, after covering a first travel distance, drives the light beam interruption element 39 over a predetermined second travel distance. The light beam interruption element 39 has a light-impermeable tab in the form of an interrupter finger which, at least on mounting of the ink cartridge 10, is movable through the light beam between the light-transmitting part 31 and the light-receiving part 32, as shown on an enlarged scale in FIG. 2. The interrupter finger extends approximately parallel to the front face 11 and to the longitudinal extent thereof, that is to say approximately vertically downwards in the case of the exemplary embodiment shown herein. It is held by a longitudinally displaceably mounted strip element 42. In accordance with FIGS. 1 and 2, the driver element, in the form of a tappet, is mounted so as to be longitudinally displaceable parallel to the strip element 42 of the light beam interruption element, reference again being made to the Applicant's DE 10 2009 026 107.9 in respect of the specific structure.

It is of particular importance that the light beam interruption element 39, which is of finger-like construction, has a truncated-cone-shaped basic structure, that is to say starting from the strip element 42 it tapers approximately conically towards the bottom. It is also of importance that the surface of the finger-like light beam interruption element 39 is textured, that is to say has transverse grooves. Specifically, the surface describes a continuous corrugation in the longitudinal direction of the interrupter finger. That surface texture is intended to ensure that any accidental splashes of ink adhere to the interrupter finger and do not drip onto the light beam entry and exit surfaces 30 and 35 located therebelow.

The cross-section of the interrupter finger 39 can be circular or elliptical with the longer axis being approximately parallel to the longitudinal extent of the strip element 42.

A further, upper interrupter projection 43 is provided, especially integrally formed, on the upper front edge of the cartridge 10. This projection is therefore located at the upper end of the front face 11 of the ink cartridge 10. It has three approximately parallel ribs, the ribs defining two receiving spaces which extend parallel to one another and are open at the front and at the top, into which firstly a light-transmitting part and secondly a light-receiving part project when the ink cartridge is mounted. Accordingly, the mounting or demounting of a cartridge is detected at this location also, insofar as this is desired and intended. On mounting, the light beam between the light-transmitting part and the light-receiving part is interrupted by the middle rib. That middle rib has a textured surface, more specifically the surface of the middle rib is corrugated on both sides, as shown very clearly in FIG. 1. Furthermore, the basic structure of the middle rib is such that the irradiated surfaces both in the vertical direction and in the horizontal direction each define a wedge-shaped body. The middle rib is therefore of twofold wedge-shaped construction. The surfaces of the middle rib that interrupt the light beam therefore in no case extend at a right angle to the light beam of the mounting detection device, this being a separate mounting detection device which can be provided in addition to the mounting detection device assigned to the light beam interruption element 39.

Alternatively, it is also possible for only the upper mounting detection device to be provided. Ultimately this depends also upon the structure of the cartridge holder or the associated printer and the detection means integrated therein.

1.-14. (canceled)

15. An ink cartridge (10) for an inkjet printer having a light-transmitting part (31) and a light-receiving part (32), the ink cartridge comprising:
a side face (11, 14, 15, 16);
an ink-receiving space including an extension (33) that projects beyond the side face; and
fill level detection means arranged on the side face, the fill level detection means operative between the light-transmitting part (31) and the light-receiving part (32) when mounted on the ink jet printer, the fill level detection means including,
a first light-beam-deflecting surface that includes a light beam entry surface (30) which is arranged outside the ink cartridge (10) and faces the light-transmitting part (31),
a deflecting surface (21) configured to be wetted with ink (34) or dewetted of ink (34) inside the cartridge (10) in dependence upon a fill level of the ink (34) in the ink-receiving space, and
a second light-beam-deflecting surface that includes a light beam exit surface (35) which is arranged outside the ink cartridge (10) and faces the light-receiving part,
wherein the first and second light-beam-deflecting surfaces are combined with the deflecting surface (21) to form a common component that is part of the extension (33) of the ink-receiving space.

16. The ink cartridge according to claim 15, wherein the side face is a front face (11) of the ink cartridge in a mounting direction (19).

17. The ink cartridge according to claim 16, further comprising a lower face (13), and an ink outlet (17) on the front face (11) of the cartridge (10) close to the lower face (13), wherein the fill level detection means is arranged above the ink outlet.

18. The ink cartridge according to claim 15, wherein the light beam entry surface (30), the light beam exit surface (35), and the deflecting surface (21) are part of an approximately U-shaped deflection element (40).

19. The ink cartridge according to claim 18, wherein the light beam entry surface (30) and the light beam exit surface (35) are formed on two limbs (24, 25) and the deflecting surface (21) is formed on a bridge (26) extending between the two limbs (24, 25) of the approximately U-shaped deflection element (40).

20. The ink cartridge according to claim 19, wherein the two limbs (24, 25) of the approximately U-shaped deflection element (40) enclose an angle of less than 90 degrees.

21. The ink cartridge according to claim 20, wherein the angle is approximately from 35 degrees to 50 degrees.

22. The ink cartridge according to claim 19, wherein each of the two limbs (24, 25) of the approximately U-shaped deflection element (40) define between the light beam entry surface (30) and the light beam exit surface (35) at least one further internal light-beam-deflecting surface (31′, 32′, 33′, 34′).

23. The ink cartridge according to claim 22, wherein the at least one further internal light-beam-deflecting surface (31′, 32′, 33′, 34′) is mirrored, so that in the dewetted state a greater proportion of at least the incoming light beam is reflected.

24. The ink cartridge according to claim 19, wherein each of the two limbs (24, 25) of the approximately U-shaped deflection element (40) define between the light beam entry surface (30) and the light beam exit surface (35) at least two further internal light-beam-deflecting surfaces (31′, 32′, 33′, 34′).

25. The ink cartridge according to claim 19, wherein free ends of the two limbs (24, 25) of the approximately U-shaped deflection element (40) each include a deflecting prism (20, 27) having an outwardly directed peak and a plurality of oblique surfaces, the plurality of oblique surfaces of the two limbs including an oblique surface facing the light-transmitting part (31) defining the light beam entry surface (30) and an oblique surface facing the light-receiving part (32) defining the light beam exit surface (35), wherein the other of the plurality of oblique surfaces form internal light-beam-deflecting surfaces (31′, 34′).

26. The ink cartridge according to claim 25, wherein the deflecting prisms (20, 27) each include first and second oblique surfaces (30, 31′ and 34′, 35) arranged at an angle of approximately from 45 degrees to 100 degrees.

27. The ink cartridge according to claim 26, wherein the angle is approximately from 60 degrees to 70 degrees.

28. The ink cartridge according to claim 25, wherein the light beam entry surface (30) facing the light-transmitting part (31) is in a cross-section of the deflecting prism 20 of a shorter dimension than an opposite light-beam-deflecting surface (31′), and wherein the light beam exit surface (35) facing the light-receiving part (32) is in a cross-section of the deflecting prisms (27) of a shorter dimension than an opposite light-beam-deflecting surface (34′).

29. The ink cartridge according to claim 19, wherein the two limbs (24, 25) of the approximately U-shaped deflection element (40) have been brought together so that mutually facing surfaces (22, 23) define, in cross-section, a “V” having a peak directed downwards when the ink cartridge (10) is mounted on the ink jet printer.

30. The ink cartridge according to claim 18, wherein the approximately U-shaped deflection element (40) is formed on an upper side of the extension (33) when the ink cartridge is mounted on the ink jet printer.

31. The ink cartridge according to claim 15, wherein the fill level detection means are each an integral part of the side face.

32. The ink cartridge according to claim 15, further comprising a mounting detection device which is operative between the light-transmitting part (31) and the light-receiving part (32) in such a way that the mounting or demounting of the ink cartridge (10) is detectable, a surface of the mounting detection device that faces a light beam of the light-transmitting part (31) extending at an angle of less than 90 degrees to the light beam and also being textured.

33. The ink cartridge of claim 32, wherein the texture of the surface includes a corrugated texture.
